(19) United States
(12) Patent Application Publication
(10) Pub. No.: US 2004/0207656 A1
(43) Pub. Date: Oct. 21, 2004

(54) Apparatus and method for abstracting summarization video using shape information of object, and video summarization and indexing system and method using the same

(76) Inventors: Sang-Youn Lee, Gyeonggi-do (KR); Young-Sik Choi, Seoul (KR); Sang-Hong Lee, Gyeonggi-do (KR); Hae-Kwang Kim, Seoul (KR)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/482,749

(22) PCT Filed: Jun. 29, 2002
(86) PCT No.: PCT/KR02/01249

(30) Foreign Application Priority Data
Jun. 30, 2001 (KR) 2001/39139

(51) Int. Cl. G09G 5/00

(52) U.S. Cl. 345/723

(57) ABSTRACT

Apparatus and method for abstracting summarization video using shape information of object, and video summarization and indexing system and method using the same are disclosed. The present invention is to describe the changing shape of an object in a video segment. The present invention is a representative shape-sequence image obtained by overlapping shapes of an object with keeping its position on the screen and a texture descriptor for the sequence image. Segment-to-segment matching is possible by measuring similarity between shape sequence images using a texture descriptor applied on the image.

### TECHNICAL FIELD

The present invention relates to an image summarization and index system that uses one representing image frame of a moving pi cture as the summary information and the method thereof; and, more particularly, to a shape-sequence image abstracting apparatus and method that can show the shape change of an object in one image frame by abstracting the shape and location of the image object from each image frame that makes up a moving picture and combining the abstracted shapes and location into one image frame, an image summarization and index system using the shape-sequence image abstracting method, the method thereof, and a computer-readable recording medium for recording a program that implements the methods.

### BACKGROUND ART

The shapes of objects that a moving picture expresses are very significant for a human being to make a visual recognition. Generally, a shape descriptor that shows the shapes in a moving picture has two types: a contour-based shape descriptor and a region-based descriptor. These descriptors describe the region for image searching.

Conventionally, image frames are taken out of a moving picture and used as summary information for the moving picture. The image taken out may be the first image frame or the last one. Otherwise, when a user wants to express the change of an object based on time, a plurality of image frames may be abstracted.

However, although the shape information of the object expressed in a moving picture and the change information of the object shape are very important summary information, the movement or change in the shape of the object in a moving picture could not be expressed in the conventional methods. Moreover, to see the movement or change of the object shapes, a moving picture restoring device should be operated, which requires complicated procedures and much processing time.

Therefore, a method for editing a moving picture is required to express the change of the object shape in a moving picture efficiently, summarize and index the moving picture, and abstract the summary information and the meta-data of the moving picture, by using the object shape information.

### DISCLOSURE OF INVENTION

It is, therefore, an object of the present invention to provide a shape-sequence image abstracting apparatus and method that uses object shape information which describes the change in the shape and location of an object in one image frame by abstracting the changing shapes and location of the image object, which are caused by the movement of a camera or the object itself in a moving picture expressing the changing shapes and location of an image object, and representing them in one image frame, an image summarization and index system using the shape-sequence image abstracting method, the method thereof, and a computer-readable recording medium for recording a program that implements the methods.

In accordance with one aspect of the present invention, there is provided a shape-sequence image, which is obtained by overlapping the object of each image frame while maintaining their location in each image frame, and a texture descriptor of the shape-sequence image.

In accordance with another aspect of the present invention, there is provided descriptors that can be used for moving picture searching and moving picture segment-to-segment matching. The moving picture segment-to-segment matching can be achieved by using a texture descriptor which represents a moving picture, and by measuring similarity, such as distance, between shape-sequence images, each representing a moving picture of its own, in accordance with the embodiment of the present invention.

In accordance with another aspect of the present invention, there is provided a shape-sequence image that represents a moving picture, the shape-sequence image making it possible for a user to recognize the overall change of the object expressed in the moving picture without making the user search the whole content of the moving picture.

In accordance with another aspect of the present invention, there is provided an image summarization and index system that can show a shape-sequence image representing a moving picture with a very small amount of information by abstracting the shape of an object from each image frame of the moving picture, converting them into a binary image, and showing the abstracted binary images on one image frame.

In other words, the image summarization and index system of the present invention can summarize and index a moving picture with a very small amount of information and computation by abstracting the shape information of an image object, i.e., object shape information, from each of the image frames constituting the moving picture, and expressing the objects of the frames in one image frame, while maintaining their shape and location, thus showing how the object changes in the moving picture.

As the Internet, digital televisions, digital video disk (DVD), international mobile telecommunication-2000 (IMT-2000), and high-speed networking develop, moving picture contents are produced in various fields, such as education, games, medical services, sciences, and they are applied to multimedia databases, remote surveillance, digital TV, Internet broadcasting services, and video on demand (VOD) services. Therefore, the technologies of the present invention can be used in the above applications which requires a technology that can search moving pictures efficiently to pick out what a user wants.

### BRIEF DESCRIPTION OF DRAWINGS

The above and other objects and features of the present invention will become apparent from the following description of the preferred embodiments given in conjunction with the accompanying drawings, in which:

FIG. 1 is a block diagram illustrating a structure of an image summarization and index system in accordance with an embodiment of the present invention;

FIG. 2 is a block diagram illustrating a structure of a shape-sequence image abstracting unit of FIG. 1 in accordance with the embodiment of the present invention;

FIG. 3 is a flow chart showing a shape-sequence image abstracting method in accordance with the embodiment of the present invention; and

FIG. 4 is an exemplary view showing a shape-sequence image in accordance with the embodiment of the present invention.

### BEST MODE FOR CARRYING OUT THE INVENTION

Other objects and aspects of the invention will become apparent from the following description of the embodiments with reference to the accompanying drawings, which is set forth hereinafter.

FIG. 1 is a block diagram illustrating a structure of an image summarization and index system in accordance with an embodiment of the present invention. The image summarization and index system (i.e., moving picture searching and streaming system) includes a moving picture encoding and dividing unit 10, a shape-sequence image abstracting unit 20, a meta-data abstracting unit 30, an image database 40, a result display 50, a requesting unit 60, and a meta-data database 70.

As shown in the drawing, the moving picture encoding and dividing unit 10 performs encoding and division of a moving picture. The shape-sequence image abstracting unit 20 forms a shape-sequence image frame out of the successive image frames that constitute the encoded moving picture video segment, and extracts a texture descriptor, which shows the characteristics of a shape-sequence image frame.

The image database 40 stores the video segment encoded and divided in the moving picture encoding and dividing unit 10, the shape-sequence image frame abstracted from the shape-sequence image abstracting unit 20, and the texture descriptor. The meta-data abstracting unit 30 abstracts meta-data from the encoded moving picture video segment stored in the image database 40, the shape-sequence image frame, and the texture descriptor.

The meta-data database 70 stores the meta-data abstracted in the meta-data abstracting unit 30, and the requesting unit 60 receives a query image from a user and analyzes the query image. The result display 50 receives the encoded video segment corresponding to the query image analyzed in the requesting unit 60, the shape-sequence image frame, the texture descriptor, and the meta-data, and shows the search result to the user.

The encoded video segment, the shape-sequence image frame, the texture descriptor, and the meta-data can be provided to the user independently.

The image summarization and index system having a structure in accordance with an embodiment of the present invention is operated as follows.

The inputted moving picture is encoded and divided in the moving picture encoding and dividing unit 10, and stored in the image database 40. Then, the video segment is transmitted to the shape-sequence image abstracting unit 20, in which a shape-sequence image is formed. Here, the shape-sequence image frame of the video segment abstracted in the shape-sequence image abstracting unit 20 is stored in the image database 40.

Meanwhile, the meta-data abstracting unit 30 abstracts meta-data from the video segment and the shape-sequence image frame, respectively, and stores the meta-data in the meta-data database 70. Subsequently, the image summarization and index system (i.e., moving picture searching and streaming system) receives a query image from a user through the user requesting unit 60, processes the query image, and then displays the search result, which is the information the user wants, on the result display 50. In short, if the user requests for summary information, the image summarization and index system sends a shape-sequence image frame abstracted from the image database 40 to the user and provides searching service and moving picture streaming service through the meta-data database, upon the user's request.

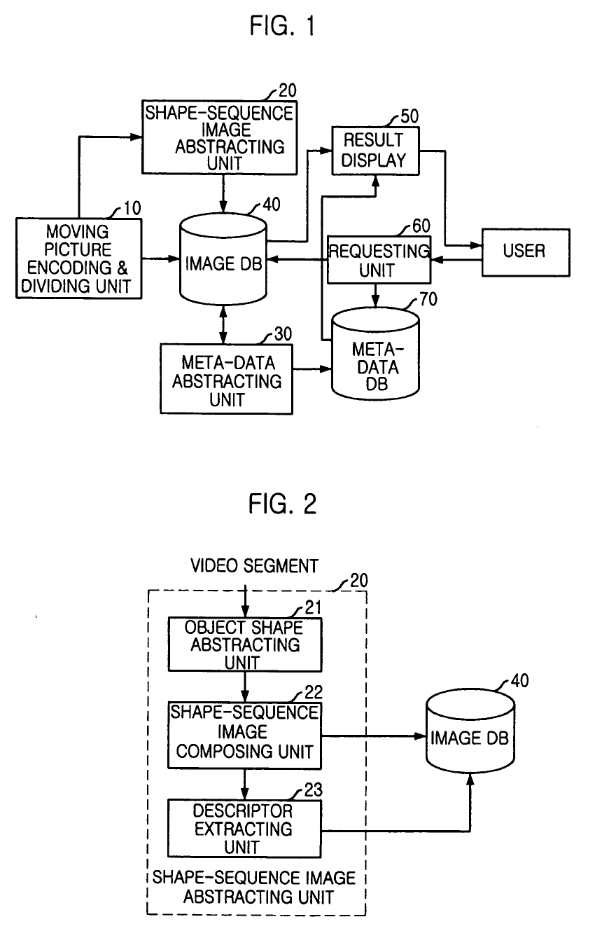

FIG. 2 is a block diagram illustrating a structure of a shape-sequence image abstracting unit of FIG. 1 in accordance with the embodiment of the present invention. The reference numeral ‘21’ denotes an object shape abstracting unit, and ‘22’ and ‘23’ denote a shape-sequence image composing unit and a descriptor extracting unit, respectively.

As shown in the drawing, the shape-sequence image abstracting unit 20 of FIG. 1 includes the object shape abstracting unit 21 for abstracting the object shape from each of the consecutive image frames that constitute an encoded video segment, the shape-sequence image composing unit 22 for composing a shape-sequence image frame by using the shape information abstracted from the object shape abstracting unit 21 and the below Equation 1 and storing the shape-sequence image frame in the image database 40, and the descriptor extracting unit 23 for extracting a texture descriptor, which also has the characteristic of a shape-sequence image, in a shape-sequence image frame transmitted from the shape-sequence image composing unit 22 to perform content-based image searching, and storing the extracted texture descriptor in the image database 40.

The object shape abstracting unit 21 abstracts the object shape from each of the consecutive image frames that constitute a video segment. Here, all types of algorithms that can abstract an object shape from an image frame can be used. For example, if a moving picture has an image object whose color is different from that of the background, a simple ‘Chroma-key’ algorithm may be used.

The abstracted pixel information of the object shape is binary information, in which the object is expressed as one value and the rest of the region, i.e., background, is expressed as the other value. The shape-sequence image composing unit 22 composes a shape-sequence image frame by using the abstracted shape information.

When the binary shape information abstracted from the i^{th} image frame that constitutes a video segment is Si, n number of consecutive binary shape information, i.e., S1, S2, . . . , Sn, are abstracted from a video segment. When the horizontal location and vertical location of the shape-sequence image frame are x and y, respectively, the value of a pixel P(x,y) can be obtained from the pixel value Si(x,y), which is the n number of binary shape information, by using the below Equation 1. Here, |denotes a logical ‘or’.

P(x,y)=S1(x,y)|S2(x,y)| . . . |Sn(x,y) Eq. 1

Each image object maintains its original location during the process of overlapping the object of each image frame with each other. Therefore, the binary shape information of each image object is abstracted to maintain the original location of each image object during the overlapping process shown in Equation 1, the central location information of each image object can be abstracted together and used for the overlapping process. The location information can be obtained from the central point of the tightest bounding box of the shape which includes the image object.

Meanwhile, the number n of overlapped image frames may be limited to a predetermined number to prevent a shape-sequence image frame from being filled up with all the images in the image object overlapping process as shown in Equation 1. There are various methods of selecting n number of image frames from a moving picture to produce a shape-sequence image frame. For example, n number of image frames can be selected with image frames that are most distinct from neighboring image frames by measuring the shape distance with an MPEG-7 shape descriptor. Also, n number of image frames can be selected at a fixed interval to maintain the same temporal interval.

The shape-sequence image information which is generated by overlapping the object of each image frame according to Equation 1 includes the trace information which shows the change in the shapes and location of the image object expressed in the corresponding moving picture. If the image frame number of a corresponding object is used for the pixel value of the object that constitutes a shape-sequence image, a particular object may be abstracted from the shape-sequence image. The shape-sequence image generated by overlapping the image objects with each other according to Equation 1 can be fixed to a predetermined size.

The descriptor extracting unit 23 extracts a descriptor that shows the characteristic of a shape-sequence image frame, which is an image frame. Various types of descriptors, which show shapes, texture and the like, can be extracted from the conventional descriptor extracting methods. Here, the extracted descriptors are stored in the image database 40 and they can be used as a descriptor vector in the content-based moving picture searching.

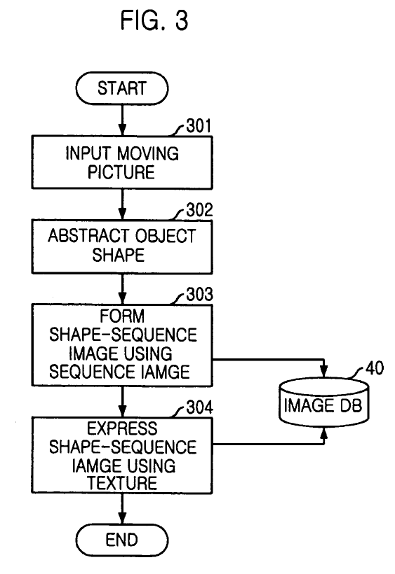

FIG. 3 is a flow chart showing a shape-sequence image abstracting method in accordance with the embodiment of the present invention. As shown in the drawing, at step 302, the shape-sequence image abstracting method in accordance with an embodiment of the present invention abstracts the object shapes from each of the consecutive image frames that constitute an encoded video segment. The image frames are inputted at step 301.

Subsequently, at step 303, a shape-sequence image frame is composed using the abstracted object shape information and Equation 1. The shape-sequence image frame is stored in the image database 40. At step 304, a texture descriptor, which shows the characteristic of the shape-sequence image and is expressed as texture, is extracted in the shape-sequence image frame to perform content-based image searching. The texture descriptor is also stored in the image database 40.

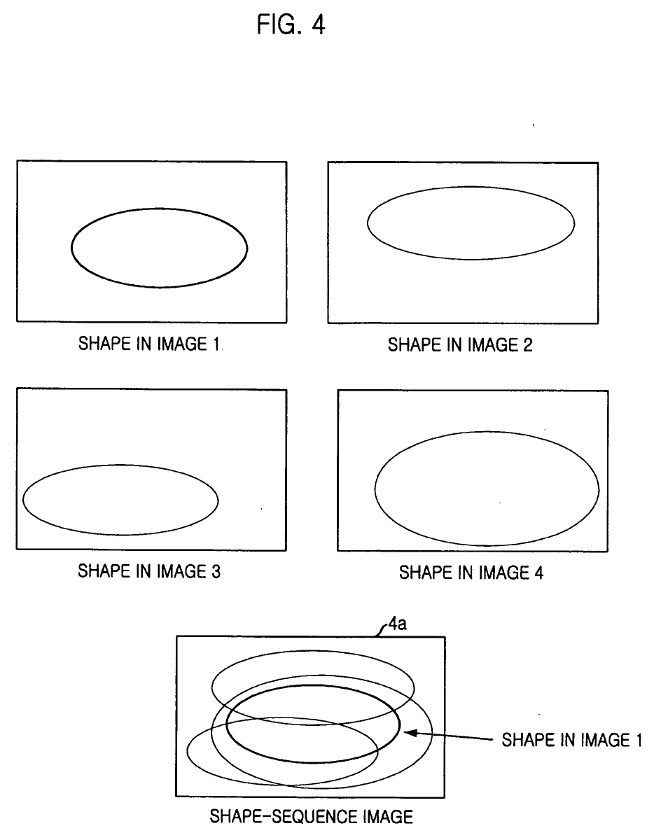

FIG. 4 is an exemplary view showing a shape-sequence image in accordance with the embodiment of the present invention. The video segment represented by the shape-sequence image includes four consecutive image frames, i.e., image 1, image 2, image 3 and image 4, and the shape and location of the image object, which is an oval, expressed in each image frame are changed, i.e., shape in image 1, shape in image 2, shape in image 3, and shape in image 4.

As described above, after the shape and location information of the image object is abstracted from each of the image frames that constitute the video segment, the shape information and the location information of each image frame are combined into one shape-sequence image frame (while their shape and location are maintained), and then displayed. Consequently, the single shape-sequence image frame contains the changing shape information of the image object, which is expressed in a moving picture (4A).

The method of the present invention can be embodied into a program, and stored in a computer-readable recording medium, such as CD-ROM, RAM, ROM, floppy disks, hard disks, optical magnetic disks, and the like.

As described above, the system and method of the present invention produces an image frame that contains the change in the shape and location of an image object, which has been impossible in the conventional technologies that present a representative image frame, thus making a user search moving pictures more effectively and efficiently.

In addition, the system and method of the present invention extracts a texture descriptor and provides it to the shape-sequence image frame so as to perform content-based searching efficiently.

Also, the system and method of the present invention makes it possible to use such moving-picture-based applications as multimedia database, remote surveillance, digital TV, Internet broadcasting services, video on demand (VOD) services, and the like, more efficiently.

While the present invention has been described with respect to certain preferred embodiments, it will be apparent to those skilled in the art that various changes and modifications may be made without departing from the scope of the invention as defined in the following claims.

What is claimed is:

1. An image summarization and index system using object shape information, comprising:
a moving picture encoding and dividing means for encoding and dividing a moving picture to generate a plurality of video segments;
a shape-sequence image abstracting means for forming a shape-sequence image frame from consecutive image frames that form the encoded video segment;
an image storing means for storing the video segment encoded and divided in the moving picture encoding and dividing means and the shape-sequence image frame abstracted from the shape-sequence image abstracting means;
a query analyzing means for receiving a query image from a user and analyzing the query image;
a result displaying unit for reading in the encoded video segment corresponding to the query image analyzed in the query analyzing means, and the shape-sequence image frame from the image storing means, and showing the corresponding result to the user.

2. The system as recited in claim 1, further comprising:
a meta-data abstracting means for abstracting meta-data from the video segment and the shape-sequence image frame, which are stored in the image storing means; and
a meta-data storing means for storing the meta-data abstracted in the meta-data abstracting means.

3. The system as recited in claim 2, wherein the result displaying means reads in the video segment corresponding to the query image analyzed in the query analyzing means, the shape-sequence image frame, and the meta-data from the image storing means and the meta-data storing means, and shows the corresponding result to the user.

4. The system as recited in any one of claims 1 to 3, wherein the shape-sequence image abstracting means forms a shape-sequence image frame from the consecutive image frames that form the video segment, and extracts a texture descriptor, which shows the characteristic of the shape-sequence image frame and is expressed as texture.

5. The system as recited in claim 4, wherein the image storing means stores the video segment which is encoded and divided in the moving picture encoding and dividing means, the shape-sequence image frame abstracted in the shape-sequence image abstracting means, and the texture descriptor.

6. The system as recited in claim 5, wherein the result displaying means reads in the video segment corresponding to the query image analyzed in the query analyzing means, the shape-sequence image frame, the texture descriptor, and the meta-data from the image storing means and the meta-data storing means, and shows the corresponding result to the user.

7. An image summarization and index system using object shape information, comprising:
a moving picture encoding and dividing means for encoding and dividing a moving picture;
a shape-sequence image abstracting means for forming a shape-sequence image frame from the consecutive images that form the encoded video segment, and extracting a texture descriptor, which shows the characteristic of a shape-sequence image frame and is expressed as texture;
an image storing means for storing the video segment encoded and divided in the moving picture encoding and dividing means, the shape-sequence image frame abstracted from the shape-sequence image abstracting means, and the texture descriptor;
a meta-data abstracting means for abstracting meta-data from the encoded video segment, the shape-sequence image frame, and the texture descriptor, which are stored in the image storing means;
a meta-data storing means for storing the meta-data abstracted in the meta-data abstracting means;
a query analyzing means for receiving a query image from a user and analyzing the received query image; and
a result displaying unit for reading in the encoded video segment corresponding to the query analyzed in the query analyzing means, the shape-sequence image frame, the texture descriptor, and the meta-data from the image storing means and the meta-data storing means, and shows the corresponding result to the user.

8. The system as recited in claim 7, wherein the shape-sequence image abstracting means includes:
an object shape abstracting means for abstracting the object shape from the consecutive images that form the encoded video segment; and
a shape-sequence image composing means for forming a shape-sequence image frame by using the shape information abstracted in the object shape abstracting means and storing the shape-sequence image frame in the image storing means,
wherein the shape-sequence image is expressed by an equation as:
P(x,y)=S1(x,y)|S2(x,y)| . . . |Sn(x,y)
where Si is the i^{th} binary shape information of a video segment, P(x,y) being a pixel value of a shape-sequence image frame whose horizontal location and vertical location are x and y, respectively, Si(x,y) being a pixel value of a binary shape information at the same location, and | being a logical OR.

9. The system as recited in claim 8, further comprising:
a descriptor extracting means for extracting a texture descriptor, which shows the characteristic of a shape-sequence image frame and is expressed as texture, from the shape-sequence image frame transmitted from the shape-sequence image composing means, and storing the extracted texture descriptor in the image storing means.

10. An apparatus for abstracting a shape-sequence image, using object shape information, comprising:
an object shape abstracting means for abstracting the object shape from the successive images that form an encoded video segment; and
a shape-sequence image composing means for forming a shape-sequence image frame by using the shape information abstracted in the object shape abstracting means,
wherein the shape-sequence image is expressed by an equation as:
P(x,y)=S1(x,y)|S2(x,y)| . . . |Sn(x,y)
where Si is the i^{th} binary shape information of a video segment, P(x,y) being a pixel value of a shape-sequence image frame whose horizontal location and vertical location are x and y, respectively, Si(x,y) being a pixel value of a binary shape information at the same location, and | being a logical OR.

11. The apparatus as recited in claim 10, further comprising:
a descriptor extracting means for extracting a texture descriptor, which shows the characteristic of a shape-sequence image frame and is expressed as texture, from the shape-sequence image frame to perform content-based image searching.

12. The apparatus as recited in any of claims 10 and 11, wherein the shape information, which is binary information, is the pixel information of the object that shows if the pixel is in the contour of the object or in the other region.

13. A method for abstracting a shape-sequence image, which is applied to a shape-sequence image abstracting apparatus, comprising the steps of:
a) abstracting the object shapes from the successive images that form an encoded video segment; and
b) forming a shape-sequence image frame by using the abstracted shape information,
wherein the shape-sequence image is expressed by an equation as:
P(x,y)=S1(x,y)|S2(x,y)| . . . |Sn(x,y)
where Si is the i^{th} binary shape information of a video segment, P(x,y) being a pixel value of a shape-sequence image frame whose horizontal location and vertical location are x and y, respectively, Si(x,y) being a pixel value of a binary shape information at the same location, and | being a logical OR.

14. The method as recited in claim 13, further comprising the step of:
c) extracting a texture descriptor, which shows the characteristic of a shape-sequence image frame and is expressed as texture, from the shape-sequence image frame to perform content-based image searching.

15. The method as recited in any one of claims 13 and 14, wherein the shape information, which is binary information, is the pixel information of the object that shows if the pixel is in the contour of the object or in the other region.

16. A computer-readable recording medium for recording a program in a shape-sequence image abstracting apparatus provided with a processor, comprising the steps of:
a) abstracting the object shapes from the successive images that form an encoded video segment; and
b) forming a shape-sequence image frame by using the abstracted shape information,
wherein the shape-sequence image is expressed by an equation as:
P(x,y)=S1(x,y)|S2(x,y)| . . . |Sn(x,y)
where Si is the i^{th} binary shape information of a video segment, P(x,y) being a pixel value of a shape-sequence image frame whose horizontal location and vertical location are x and y, respectively, Si(x,y) being a pixel value of a binary shape information at the same location, and | being a logical OR.

17. The computer-readable recording medium as recited in claim 16, further comprising the step of:
c) extracting a texture descriptor, which shows the characteristic of a shape-sequence image frame and is expressed as texture, from the shape-sequence image frame to perform content-based image searching.
